(19) United States
(12) Patent Application Publication
(10) Pub. No.: US 2014/0032252 A1
(43) Pub. Date: Jan. 30, 2014

(54) WRONGDOING REPORTING SYSTEM AND METHOD AND STORAGE MEDIUM FOR THE SAME

(71) Applicant: Joong-Hee LEE, Anyang (KR)

(72) Inventor: Joong-Hee LEE, Anyang (KR)

(21) Appl. No.: 13/935,433

(22) Filed: Jul. 3, 2013

(30) Foreign Application Priority Data
Jul. 30, 2012 (KR) 2012-0083500

(51) Int. Cl. G06Q 10/06; G06Q 30/02

(52) U.S. Cl. CPC G06Q 10/063; G06Q 30/0217
USPC 705/7.11

(57) ABSTRACT

Disclosed herein is a wrongdoing reporting system and method, and a storage medium for the same. In the wrongdoing reporting method, a report of a wrongdoing is received from a reporter client, wherein the reporter client is a mobile client on which a wrongdoing reporting application is executed and the report of the wrongdoing includes an organization unique code, a report unique, and report details information. The report details information is transmitted to an organization client previously registered for the organization unique code. Results of actions against the report details information are received from the organization client, wherein the results of the actions include an organization unique code, a report unique code, and action result details information. The action result details information is transmitted to a reporter client corresponding to the report unique code.

### CROSS REFERENCE RELATED APPLICATION

This application claims foreign priority of Korean Patent Application No. 2012-0083500, filed on Jul. 30, 2012, which is incorporated by reference in its entirety into this application.

### BACKGROUND OF THE INVENTION

1. Field of the Invention

The present invention relates, in general, to a wrongdoing reporting system and method and a storage medium for the system and method and, more particularly, to a wrongdoing reporting system and method and a storage medium for the system and method, which process the reports of wrongdoings occurring within various types of enterprises or organizations, and which are configured to improve the effect of guaranteeing the anonymity of reporters using a reporter client that is executed in the form of an application (APP) of a mobile client, and to securely and efficiently process the payment of compensations to the reporters by providing an escrow function.

2. Description of the Related Art

The action by which members belonging to various organizations, such as enterprises or government organizations, expose wrongdoings or illegal activities/unreasonable activities occurring in their organizations to the public or a third party is called whistleblowing. Since organizations defensively/retaliatively deal with the exposure of wrongdoings by whistleblowers, without exception, each country has established laws for protecting whistleblowers in order to protect accusers who make accusations capable of contributing to the benefit of the entirety of a larger society, such as a nation, rather than the benefit of a subgroup of society.

However, in spite of such legal protection, the reality is that whistleblowers are exposed to various types of defensive/retaliative actions taken by organizations, and this has become a fundamental factor hindering whistleblowing.

Technologies for solving this problem have been proposed. For example, Korean Patent No. 10-0846908 (Date of registration: Jul. 10, 2008) discloses technology for integrally providing a whistleblowing service to enterprises which subscribe as members, wherein, for such a service, the technology allows whistleblowers to anonymously enter the details of a whistleblowing report against a specific enterprise over a communication network, such as the Internet, and to easily confirm results processed by the corresponding enterprise against the details of the whistleblowing report over the communication network, without revealing themselves.

However, the conventional whistleblowing system and method are configured such that a procedure for allowing a whistleblower to enter accusation details or confirm the results of processing against the accusation is implemented in the form of a web service. Accordingly, there is a limitation in that accusation details or the procedure for processing the accusation may be leaked via a web page open to an unspecified number of the general public.

Further, since the conventional technology does not provide the function of processing a compensation payment for whistleblowing, there is a limitation in that no compensation is paid to whistleblowers who attempt to blow the whistle while enduring the retaliative actions taken by organizations. In particular, in order to pay compensation to the whistleblowers, personal information, such as the personal items or account information of the whistleblowers, is required. In this case, when the functions of entering, confirming, and managing such personal information are assigned due to the characteristics of a web service model, there is a limitation in that the potential risk of information being unexpectedly leaked is present.

Furthermore, there is a limitation in that the potential risk of information being unexpectedly leaked is present even during a procedure for transferring compensation provided by the corresponding organization to a whistleblower.

### SUMMARY OF THE INVENTION

Accordingly, the present invention has been made keeping in mind the above problems occurring in the prior art, and an object of the present invention is to provide a wrongdoing reporting system and method and a storage medium for the system and method, which process the reports of wrongdoings occurring within various types of enterprises or organizations, and which are configured to improve the effect of guaranteeing the anonymity of reporters using a reporter client that is executed in the form of an application (APP) of a mobile client, and to securely and efficiently pay compensation to the reporters by providing an escrow function.

In accordance with an aspect of the present invention to accomplish the above object, there is provided a wrongdoing reporting method, the method being performed by a wrongdoing reporting system operating in conjunction with at least one reporter client and at least one organization client over a communication network and processing reports of wrongdoings of an organization, received from the reporter client, including (a) receiving a report of a wrongdoing from a reporter client, wherein the reporter client is a mobile client on which a wrongdoing reporting application is executed and the report of the wrongdoing includes an organization unique code, a report unique, and report details information; (b) transmitting the report details information to an organization client previously registered for the organization unique code; (c) receiving results of actions against the report details information from the organization client, wherein the results of the actions include an organization unique code, a report unique code, and action result details information; and (d) transmitting the action result details information to a reporter client corresponding to the report unique code.

In accordance with another aspect of the present invention to accomplish the above object, there is provided a computer-readable storage medium for storing a program for executing the wrongdoing reporting method.

In accordance with a further aspect of the present invention to accomplish the above object, there is provided a wrongdoing reporting system, the system operating in conjunction with at least one reporter client and at least one organization client over a communication network and processing reports of wrongdoings of an organization received from the reporter client, including a reporter client interworking module for performing a function of receiving a report of a wrongdoing from a reporter client and a function of transmitting action result details information received from an organization client to a reporter client corresponding to a report unique code, wherein the reporter client is a mobile client on which a wrongdoing reporting application is executed, and the report of the wrongdoing includes an organization unique code, the report unique code, and report details information; and an organization client interworking module for performing a function of transmitting the report details information received from the reporter client to an organization client previously registered for the organization unique code, and a function of receiving results of actions against the report details information from the organization client, wherein the action results include an organization unique code, a report unique code, and action result details information.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the overall configuration of a wrongdoing reporting system according to an embodiment of the present invention;

FIG. 2 is a diagram showing the configuration of a wrongdoing reporting system from the standpoint of functionality according to an embodiment of the present invention;

FIG. 3 is a diagram showing the configuration of a reporter client from the standpoint of functionality according to an embodiment of the present invention;

FIG. 4 is a flowchart showing a wrongdoing reporting method according to an embodiment of the present invention; and

FIG. 5 is a flowchart showing a wrongdoing reporting method according to another embodiment of the present invention.

### DESCRIPTION OF THE PREFERRED EMBODIMENTS

The present invention can be implemented in various forms without departing from the technical spirit or principal features of the present invention. Therefore, the embodiments of the present invention are merely illustrative in all aspects and should not be interpreted as restrictive.

The terms such as “first” and “second” may be used to describe various components, but those components should not be limited by the terms. The terms are merely used to distinguish one component from other components. For example, a first component may be designated as a second component and a second component may be designated as a first component in a similar manner, without departing from the scope based on the concept of the present invention. The term ‘and/or’ includes any and all combinations of one or more of the associated listed items.

Throughout the entire specification, it should be understood that a representation indicating that a first component is “connected” or “coupled” to a second component may include the case where the first component is connected or coupled to the second component with some other component interposed therebetween, as well as the case where the first component is “directly connected” or “directly coupled” to the second component. In contrast, it should be understood that a representation indicating that a first component is “directly connected” or “directly coupled” to a second component means that no component is interposed between the first and second components.

The terms used in the present specification are merely used to describe specific embodiments and are not intended to limit the present invention. A singular expression includes a plural expression unless a description to the contrary is specifically pointed out in context. In the present specification, it should be understood that the terms such as “comprise,” “include” or “have” are merely intended to indicate that features, numbers, steps, operations, components, parts, or combinations thereof are present, and are not intended to exclude a possibility that one or more other features, numbers, steps, operations, components, parts, or combinations thereof will be present or added.

Unless differently defined, all terms used here including technical or scientific terms have the same meanings as the terms generally understood by those skilled in the art to which the present invention pertains. The terms identical to those defined in generally used dictionaries should be interpreted as having meanings identical to contextual meanings of the related art, and are not interpreted as being ideal or excessively formal meanings unless they are definitely defined in the present specification.

Hereinafter, embodiments of the present invention will be described in detail with reference to the attached drawings. Reference now should be made to the drawings, in which the same reference numerals are used throughout the different drawings to designate the same or similar components, and redundant descriptions thereof will be omitted. In the following description, redundant descriptions and detailed descriptions of known functions and elements that may unnecessarily make the gist of the present invention obscure will be omitted.

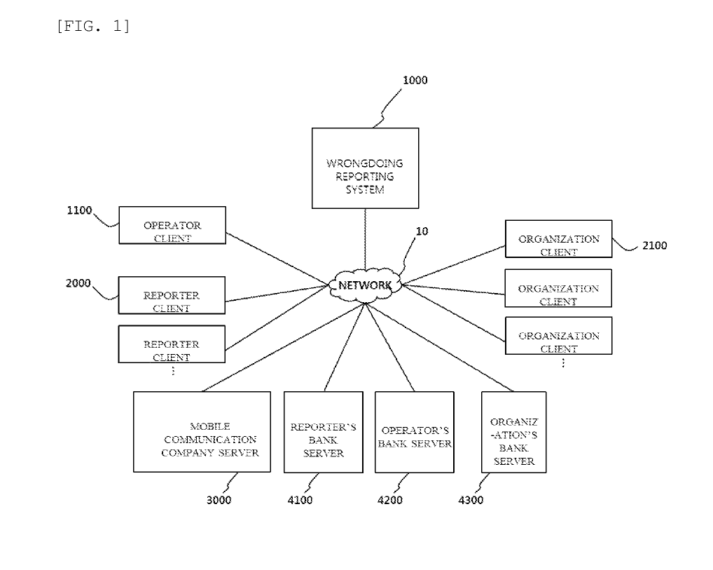

FIG. 1 is a diagram showing the overall construction of a wrongdoing reporting system according to an embodiment of the present invention.

In the present invention, there is provided a wrongdoing reporting system 1000 for processing the reports of wrongdoings of organizations, which are transmitted from reporter clients 2000. The wrongdoing reporting system 1000 is configured to operate in conjunction with reporter clients 2000 and organization clients 2100 over a communication network 10. The communication network 10 refers to a typical communication network, such as the Internet, and may be understood to comprehend all wired/wireless networks. In particular, the communication network 10 includes a mobile communication network, such as a Wideband Code Division Multiple Access (WCDMA) network or a Long Term Evolution (LTE) network, so that mobile clients can be connected to the mobile communication network.

The term “organization” may be understood to be a normal enterprise or a public institution (a government institution, a local government, an affiliated organization, a public enterprise, or the like) which desires to receive the reports of internal wrongdoings from reporters, in particular, whistleblowers, ascertain the reports, and correct the wrongdoings. In particular, in the present embodiment, “organization” may be understood to be an organization which has subscribed to the wrongdoing reporting system 1000 as a member for a wrongdoing reporting service.

It is preferable to input organization information, such as the name of an organization, a category of business, a location, a company representative, and a phone number, when each organization registers as a member. Further, it is preferable to input the personal data, ID and password of a person in charge of processing wrongdoing reports, who is authorized to use the corresponding organization client 2100 and has the right to check the details of wrongdoings reported by reporters, take corrective actions, and process compensation for reporting, together with the above organization information, when the organization registers as a member. It is apparent that the authority to use the organization client 2100 may be extended to another person or may be changed via a suitable authentication procedure.

The term “reporter” may be understood to be a person who anonymously reports wrongdoings occurring within an organization. Preferably, the reporter may be a whistleblower belonging to the corresponding organization.

Each reporter client 2000 is a mobile client on which a wrongdoing reporting application (APP) is executed, and may be implemented as, for example, a typical smart phone or smart pad, which uses a mobile communication network, such as a WCDMA or LTE network. The wrongdoing reporting application is an application distributed by the operator of the wrongdoing reporting system 1000 so that the application can be used by reporters. Such an application can be distributed via, for example, a typical APP store server (not shown) that operates in conjunction with the wrongdoing reporting system 1000.

The term “APP” denotes an application program executed only on the corresponding mobile device using a development language provided by a mobile Operating System (OS) manufacturer. APP has the support of hardware functions provided by a device to implement various types of functions, and is not accessed in the form of an open page, such as a web page.

The web provides the function of simply browsing information on the Internet and reconfiguring the information in conformity with the specification and User Interface (UI) of a specific device, without needing to support special hardware functions, and is configured to be easily accessed via an open web page.

In the present embodiment, since the reporter client 2000 is implemented as a mobile client on which the wrongdoing reporting APP is executed, security can be improved compared to an open web page when a reporter conducts a reporting activity. Further, as will be described later, a more personalized transmission scheme such as a push message form (or a messenger form), rather than a request/reception scheme based on a web page, can be applied to the client when the wrongdoing reporting system 1000 transmits information about the details of the action results.

Meanwhile, preferably, the wrongdoing reporting APP is configured to be executable only when the unique code of an organization, the wrongdoing of which is desired to be reported, is input after the APP has been downloaded and installed on the reporter client 2000. For example, the input of such an organization unique code can be performed in such a way that organization unique code information, downloaded together with the APP when the APP is initially downloaded, is presented on the screen of the mobile client, and the user of the mobile client selects a specific organization unique code. Such an input scheme may be regarded as a scheme optimized for a case where a reporter belonging to a specific organization reports a wrongdoing in the form of whistleblowing. Owing to this scheme, there is an advantage in that when the reporter runs the wrongdoing reporting APP and desires to report the wrongdoing of a specific organization through the reporter client, the organization that is currently being reported by the reporter may not be exposed to the screen.

The organization client 2100 may also be understood to be a client that is used by a person in charge of processing the reports of wrongdoings of the organization registered as a member. The person in charge of processing wrongdoing reports may be understood to be, for example, a person having the right to process wrongdoings in the ethical management department of the organization. The organization client 2100 is a client used in the organization and may be implemented using, for example, a typical computing means (for example, a Personal Computer: PC) which can use web services.

In the present invention, an operator client 1100 for operating the wrongdoing reporting system 1000 is provided. The operator client 1100 checks details applied by a target organization which desires to use the wrongdoing reporting service, performs the processing of registration and confirmation based on the application and processing related to compensation, and processes an overall management task required to operate the wrongdoing reporting system 1000.

In the present invention, a mobile communication company server 300 is provided which performs a mobile communication service so that each reporter client 2000 can operate in conjunction with the wrongdoing reporting system 1000 over a mobile communication network. The mobile communication company server 3000 manages the communication subscriber identification (ID) code of each reporter client so as to provide a mobile communication service.

The communication subscriber ID code may be, for example, International Mobile Subscriber Identity (IMSI) used in the WCDMA or LTE network. The structure of the IMSI is composed of “MCC+MNC+phone number” and is a 15-digit number. Here, MCC is an abbreviated form of a Mobile Country Code corresponding to a country code, and MNC is an abbreviated form of a Mobile Network Code corresponding to a communication company code. IMSI is stored in, for example, the Universal Subscriber Identity Modules (USIM) card of the mobile client, and is used as a basis for determining whether to permit network access upon accessing a mobile communication network, classifying services to be used, setting billing criteria, etc. It is apparent that any type of code besides IMSI can be used as the communication subscriber identification code as long as it enables the mobile client to be identified.

As will be described later, when the payment of compensation to the reporter is processed, a reporter's bank server 4100, an operator's bank server 4200, and an organization's bank server 4300 may operate in conjunction with the wrongdoing reporting system 1000 over the communication network 10, in order to transfer compensation. The operator's bank server 4200 may function as a server for managing an escrow account.

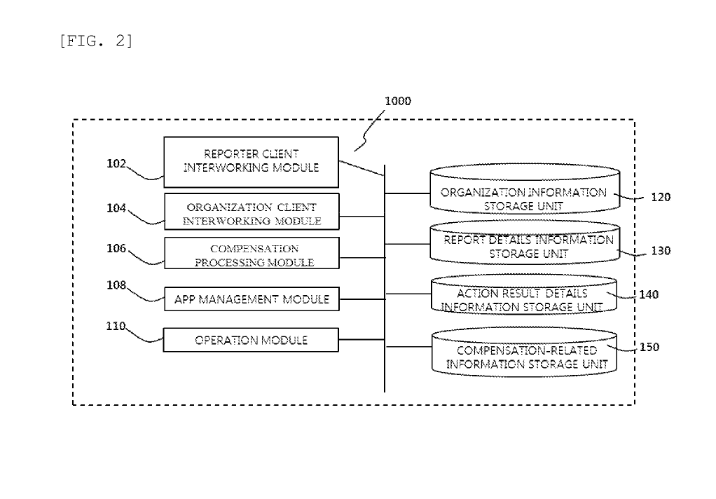

FIG. 2 is a diagram showing the configuration of a wrongdoing reporting system from the standpoint of functionality according to an embodiment of the present invention.

A wrongdoing reporting system 1000 includes a reporter client interworking module 102, an organization client interworking module 104, and a compensation processing module 106 so as to process the report of a wrongdoing of an organization, transmitted from each reporter client 2000.

Further, the wrongdoing reporting system 1000 includes an application (APP) management module 108 for managing a wrongdoing reporting APP so that the reporter client 2000 can download the wrongdoing reporting APP in conjunction with an APP store server (not shown).

Furthermore, the wrongdoing reporting system 1000 includes an operation module 110 for processing an overall management task required to operate the wrongdoing reporting system 1000 in conjunction with the operator client 1100.

The reporter client interworking module 102 performs the function of receiving the report of a wrongdoing from the reporter client 2000 and the function of transmitting information about the details of the action results received from the organization client 2100 to a reporter client 2000 corresponding to a given report unique code.

The report of the wrongdoing includes an organization unique code, a report unique code, and report details information.

The organization unique code may be understood to be a unique code assigned to a specific organization when the specific organization subscribes to the wrongdoing reporting system 1000 as a member for a wrongdoing reporting service.

The report unique code may be understood to be a unique code entered by a reporter when the reporter reports wrongdoings using the reporter client 2000, and is used to identify the corresponding report details during a subsequent procedure for processing the report. The report unique code is differentiated from a typical password used to access specific information on an open web page in that the report unique code is an identification code corresponding to report details.

The report details information refers to information about the details of a wrongdoing report entered by the reporter when the reporter reports wrongdoings using the reporter client 2000, and is preferably entered based on five W's and one H, such as when, where, who, what, how, and why.

The organization client interworking module 104 performs the function of transmitting the report details information received from the reporter client 2000 to an organization client 210 previously registered for the corresponding organization unique code, and the function of receiving the results of actions against the report details information from the organization client 2100.

The results of the actions include an organization unique code, a report unique code, and action result details information.

The action result details information refers to information about the results of ascertaining whether the reported wrongdoing has actually occurred, the necessity to take corrective actions against the wrongdoing, the results of the corrective actions, etc.

The organization unique code or the report unique code included in the action results may be input together when the details of action results are input from the organization client 2100, but may be automatically identified when receiving an ID and a password from an organization client 2100 which requests access permission to input the action result details.

The compensation processing module 106 processes compensations such that compensation is transferred from an organization account and is then transferred from an escrow account, in which funds allocated for compensations are held, to the compensation receipt account of the reporter, based on compensation-related information received from the organization client 2100 and compensation receipt account information received from the reporter client 2000.

The compensation-related information includes at least one of information about whether compensation is to be paid, and information about the amount of compensation.

Meanwhile, in order to store various types of information required to process the report of the wrongdoing, the wrongdoing reporting system 1000 includes an organization information storage unit 120, a report details information storage unit 130, an action result details information storage unit 140, and a compensation-related information storage unit 150.

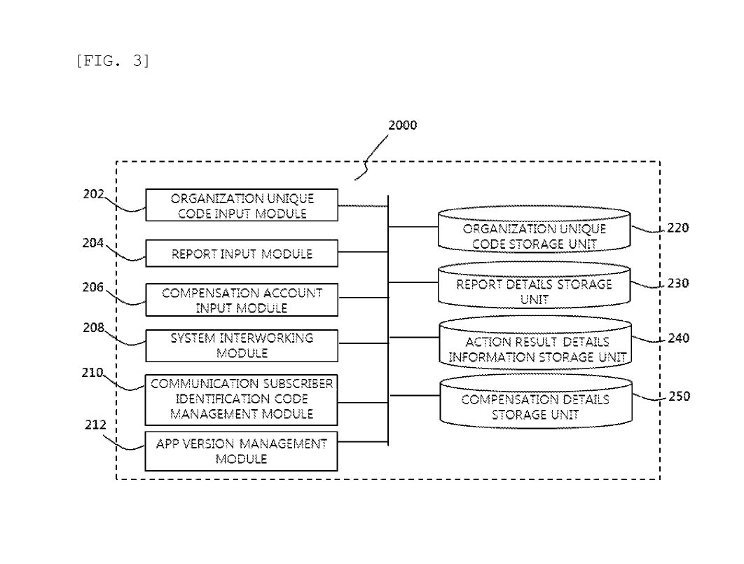

FIG. 3 is a diagram showing the configuration of a reporter client from the standpoint of functionality according to an embodiment of the present invention.

A reporter client 2000 on which a wrongdoing reporting application (APP) is installed includes an organization unique code input module 202 for inputting an organization unique code, a report input module 204 for inputting a report unique code and report details information, a compensation account input module 206 for inputting information about a compensation receipt account, a system interworking module 208 for processing the transmission/reception of various types of information to/from the wrongdoing reporting system 1000, a communication subscriber identification code management module 210 for managing a communication subscriber identification code, and an application version management module 212 for managing the version of the wrongdoing reporting APP when the wrongdoing reporting APP is updated. Although not shown in detail in the drawing, various types of well-known function modules for performing a normal mobile client function can be provided.

Further, in order to store various types of information generated during a procedure for processing the report of a wrongdoing, the reporter client 2000 includes an organization unique code storage unit 220, a report details storage unit 230, an action result details information storage unit 240, and a compensation details storage unit 250.

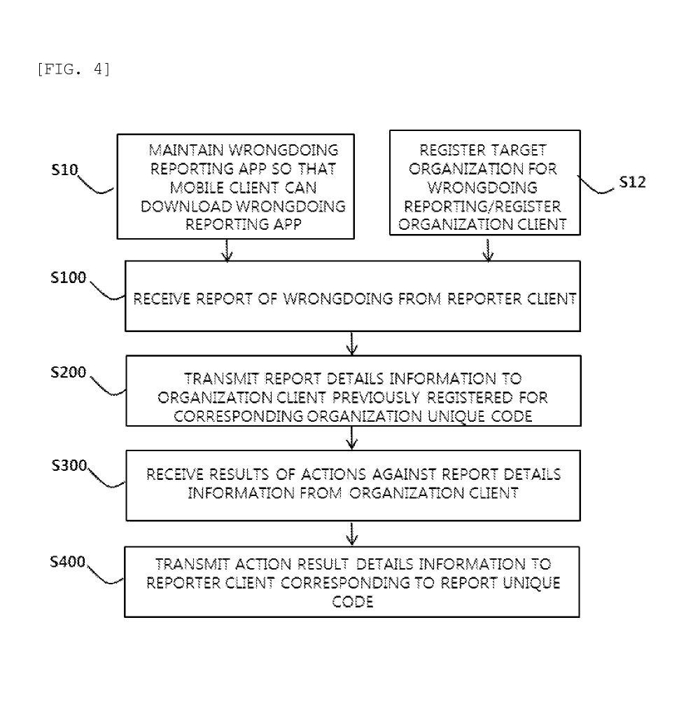

FIG. 4 is a flowchart showing a wrongdoing reporting method according to an embodiment of the present invention.

A wrongdoing reporting APP is maintained such that a mobile client can download the wrongdoing reporting APP at step S10. Here, the term “maintenance” means that the wrongdoing reporting APP is maintained such that it can be distributed through a typical APP store server (not shown) operating in conjunction with the wrongdoing reporting system 1000, and does not necessarily mean that the wrongdoing reporting system is maintained in a directly downloadable state.

The report of a wrongdoing is received from a reporter client at step S100. The reporter client is a mobile client on which the wrongdoing reporting APP is executed, and the report of the wrongdoing includes an organization unique code, a report unique code, and report details information. Preferably, the reporter client is allowed to confirm the normal reception of the report of the wrongdoing in a push message form (or a messenger form).

The report details information is transmitted to an organization client previously registered for the corresponding organization unique code at step S200. Here, “transmission” may be performed in such a way that, for example, an ID and a password are entered in the web page of the wrongdoing reporting system and web page information is sent at the request of a connected organization client.

The results of actions against the report details information are received from the organization client at step S300. The results of the actions include an organization unique code, a report unique code, and action result details information.

The action result details information is transmitted to the reporter client corresponding to the report unique code at step S400.

Here, step S400 may be implemented using the following two methods.

In a first method, step S400 is configured such that an action result confirmation request signal is received from the reporter client at step S410, and action result details information corresponding to the received report unique code is transmitted to the reporter client at step S412. In this case, the action result confirmation request signal includes at least the report unique code.

In a second method, the communication subscriber identification code of the reporter client is further received at step S100, and step S400 is configured such that action result details information corresponding to the report unique code is transmitted to the reporter client using the communication subscriber identification code in a push message form at step S420.

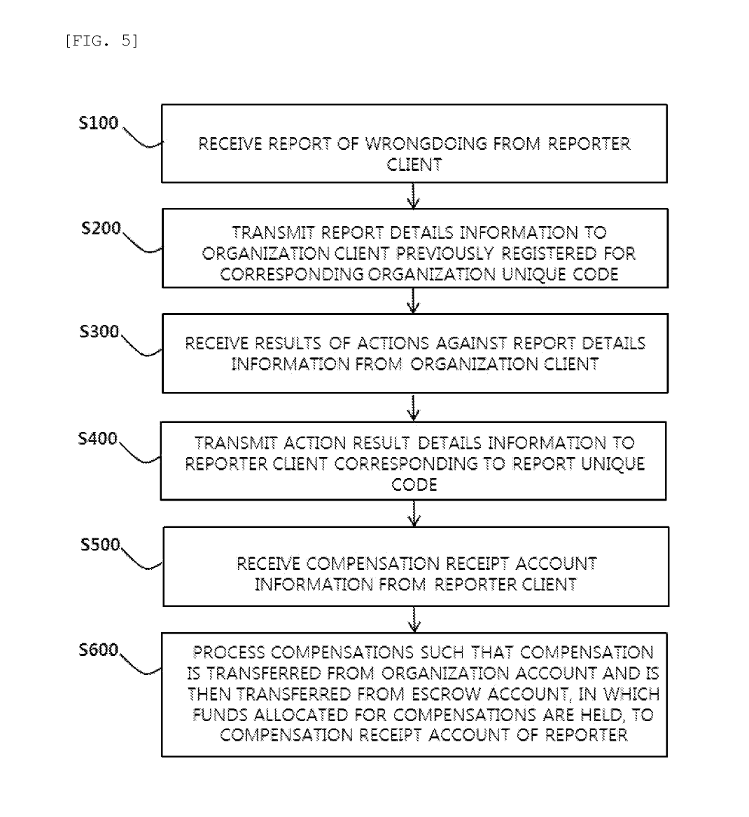

FIG. 5 is a flowchart showing a wrongdoing reporting method according to another embodiment of the present invention.

In the present embodiment, a basic report processing procedure ranging from step S100 to S400 is identical to that of the above embodiment, but a procedure for processing the payment of compensation to the reporter is further provided.

For this, action results at step S300 further include compensation-related information for the reporter. The compensation-related information includes at least one of information about whether compensation is to be paid, and information about the amount of compensation. Further, at step S400, the compensation-related information is further transmitted to the reporter client.

After step S400, processing is performed such that information about a compensation receipt account is received from the reporter client at step S500, and compensation is transferred from an escrow account to the compensation receipt account of the reporter at step S600. For this operation, the escrow account holds funds for compensations that have been transferred from an organization account and are saved.

Meanwhile, the compensation receipt account is the account of the reporter opened in the reporter's bank server 4100, the escrow account is the account of the operator opened in the operator's bank server 4200, and the organization account is the account of the organization opened in the organization's bank server 4300.

Meanwhile, in order to improve the precision and security of the above compensation processing procedure, the following configuration can be implemented.

Step S100 is configured such that the communication subscriber identification code of the reporter client may be further received. Step S400 is configured such that the action result details information and compensation-related information corresponding to the received report unique code are transmitted to the reporter client using the communication subscriber identification code in a push message form. The communication subscriber identification code may be automatically collected and transmitted upon executing the wrongdoing reporting APP. For this, it is preferable to provide a reporter consent procedure during an APP installation procedure.

Further, at step S500, the communication subscriber identification code of the reporter client together with compensation receipt account information are further received from the reporter client. If it is determined that the communication subscriber identification code identical to the communication subscriber identification code received at step S100 has been received, step S600 is performed.

In this way, there is an advantage in that when the communication subscriber identification code is used to identify the personal information of the reporter, a compensation transfer procedure may be performed merely by transmitting compensation receipt account information using the reporter client even if the reporter does not enter detailed personal information to receive compensation. For this operation, the effect of guaranteeing the anonymity of the reporter can be further improved.

Embodiments of the present invention include computer-readable storage media having program instructions for performing operations implemented on various computers. The computer-readable storage media may include program instructions, data files, data structures, etc. alone or in combination. The media may be designed or configured especially for the present invention, or may be well-known to and used by those skilled in the art of computer software. Examples of the computer-readable storage media may include magnetic media such as a hard disk, a floppy disk, and magnetic tape, optical media such as Compact Disk-Read Only Memory (CD-ROM) and a Digital Versatile Disk (DVD), magneto-optical media such as a floptical disk, and hardware devices especially configured to store and execute program instructions such as ROM, Random Access Memory (RAM), and flash memory. Meanwhile, such a storage medium may be a transfer medium such as light, a metal wire or a waveguide including carrier waves for transmitting signals required to designate program instructions, data structures, etc. Examples of program instructions include not only machine language codes created by compilers, but also high-level language codes that can be executed on computers using interpreters or the like.

In accordance with the present invention, there is an advantage in that the reports of wrongdoings occurring within various types of enterprises or organizations are processed, and a reporter client, which is executed in the form of an application (APP) of a mobile client, is used, thus maximizing the effect of guaranteeing the anonymity of a reporter compared to a web service scheme.

Further, there is an advantage in that an escrow function is provided, so that the processing of the payment of compensation to a reporter can be securely and efficiently performed while the anonymity of the reporter is guaranteed, thus improving a person's motivation to report wrongdoings.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A wrongdoing reporting method, the method being performed by a wrongdoing reporting system operating in conjunction with at least one reporter client and at least one organization client over a communication network and processing reports of wrongdoings of an organization, received from the reporter client, comprising:
(a) receiving a report of a wrongdoing from a reporter client, wherein the reporter client is a mobile client on which a wrongdoing reporting application is executed and the report of the wrongdoing includes an organization unique code, a report unique, and report details information;
(b) transmitting the report details information to an organization client previously registered for the organization unique code;
(c) receiving results of actions against the report details information from the organization client, wherein the results of the actions include an organization unique code, a report unique code, and action result details information; and
(d) transmitting the action result details information to a reporter client corresponding to the report unique code.

2. The wrongdoing reporting method of claim 1, wherein (d) comprises:
(d1) receiving an action result confirmation request signal from the reporter client, wherein the action result confirmation request signal includes at least the report unique code; and
(d2) transmitting action result details information corresponding to the received report unique code to the reporter client.

3. The wrongdoing reporting method of claim 1, wherein:
at (a), a communication subscriber identification code of the reporter client is further received, and
(d) further comprises (d3) transmitting action result details information corresponding to the received report unique code to the reporter client using the communication subscriber identification code in a push message form.

4. The wrongdoing reporting method of claim 1, further comprising, before (a) is performed, (pa) maintaining the wrongdoing reporting application so that the mobile client is capable of downloading the wrongdoing reporting application, wherein the wrongdoing reporting application is configured to be executable only when an organization unique code corresponding to an organization, a wrongdoing of which is desired to be reported, is input after the wrongdoing reporting application has been downloaded.

5. The wrongdoing reporting method of claim 1, wherein:
the action results at (c) further include compensation-related information for the reporter, wherein the compensation-related information includes at least one of information about whether compensation is to be paid and information about an amount of compensation, and
at (d), the compensation-related information is further transmitted to the reporter client.

6. The wrongdoing reporting method of claim 5, further comprising, after (d):
(e) receiving compensation receipt account information from the reporter client; and
(f) processing compensations such that compensation is transferred from an organization account and is then transferred from an escrow account, in which funds allocated for compensations are held, to a compensation receipt account of the reporter.

7. The wrongdoing reporting method of claim 6, wherein:
at (a), a communication subscriber identification code of the reporter client is further received,
(d) is configured to transmit the action result details information and the compensation-related information corresponding to the received report unique code to the reporter client using the communication subscriber identification code in a push message form,
at (e), a communication subscriber identification code of the reporter client, together with the compensation receipt account information, are further received from the reporter client, and (f) is performed if the communication subscriber identification code received at (a) is identical to the communication subscriber identification code received at (e).

8. A computer-readable storage medium for storing a program for executing the wrongdoing reporting method set forth in claim 1.

9. A wrongdoing reporting system, the system operating in conjunction with at least one reporter client and at least one organization client over a communication network and processing reports of wrongdoings of an organization received from the reporter client, comprising:
a reporter client interworking module for performing a function of receiving a report of a wrongdoing from a reporter client and a function of transmitting action result details information received from an organization client to a reporter client corresponding to a report unique code, wherein the reporter client is a mobile client on which a wrongdoing reporting application is executed, and the report of the wrongdoing includes an organization unique code, the report unique code, and report details information; and
an organization client interworking module for performing a function of transmitting the report details information received from the reporter client to an organization client previously registered for the organization unique code, and a function of receiving results of actions against the report details information from the organization client, wherein the action results include an organization unique code, a report unique code, and action result details information.

10. The wrongdoing reporting system of claim 9, further comprising a compensation processing module for performing a function of processing compensations such that compensation is transferred from an organization account and is then transferred from an escrow account, in which funds allocated for compensations are held, to a compensation receipt account of the reporter, based on compensation-related information received from the organization client and compensation receipt account information received from the reporter client, wherein the compensation-related information includes at least one of information about whether compensation is to be paid and information about an amount of compensation.
